(19) United States
(12) Patent Application Publication
(10) Pub. No.: US 2009/0190348 A1
(43) Pub. Date: Jul. 30, 2009

(54) ILLUMINATING DEVICE WITH LIGHT-EMITTING DIODE LIGHT

(75) Inventor: Chu-Hsien LIN, Hsinchu City (TW)

Correspondence Address: WPAT, PC, 7225 BEVERLY ST., ANNANDALE, VA, 22003, US

(73) Assignee: Chu-Hsien LIN, Hsinchu City (TW)

(21) Appl. No.: 12/355,196

(22) Filed: Jan. 16, 2009

(30) Foreign Application Priority Data
Jan. 24, 2008 (CN) 200820001870.0

(51) Int. Cl. F21V 33/00; F21V 21/00

(52) U.S. Cl. 362/235; 362/249.06

(57) ABSTRACT

An illuminating device with LED light source includes a circuit board and an elongated arch-sectioned transparent plate. The circuit board has at least two LED lamps arranged in line. The transparent plate is located below the circuit board and is large enough to cover all the LED lamps. The arch-sectioned transparent plate is provided on an outer surface with a plurality of curved ridges, which are parallelly and closely arranged side by side. Lights emitted from the LED lamps and passed through the arch-sectioned transparent plate are condensed by the curved ridges. Therefore, the arch-sectioned transparent plate with the curved ridges forms an area light source. That is, point light sources provided by the LED lamps are converted into an elongated area light source by the curved ridges.

### FIELD OF THE INVENTION

The present invention relates to an illuminating device with light-emitting diode (LED) light source, and more particularly to a device capable of converting LED point light sources into an elongated area light source, so that the device is suitable for use as an illuminating device.

### BACKGROUND OF THE INVENTION

Most of the currently available illuminating devices are fluorescent tube lamps and incandescent bulbs. The tube lamps either have an elongated tube or a ring-shaped tube. And, the bulbs generally have a spherical shape or a coil shape formed from a thin tube.

A light-emitting diode (LED) has the advantages of low power consumption, high lighting efficiency, small volume, etc. and has been widely used as an indicator lamp in electric circuits. The technique for producing LED is highly matured now, and the brightness of LED has reached the level high enough for using in illumination. Therefore, some lighting fixture manufacturers have tried to apply the LED to projection lamps.

When applying the LED to illuminating devices, it is necessary to gather a plurality of LEDs to form an illuminating lamp having sufficient brightness to substitute for conventional fluorescent tube lamps and incandescent bulbs. However, the LED has a relatively small volume to provide only a point light source. When lights from two or more point light sources are projected on an object, there will be overlapped images to cause visual deviation.

It is therefore an important issue of how to effectively apply the LEDs to illuminating devices.

### SUMMARY OF THE INVENTION

A primary object of the present invention is to provide an illuminating device with LED light source, which is able to convert a plurality of LED point light sources into a complete area light source, so as to provide more evenly projected lights and upgraded illuminating effect.

To achieve the above and other objects, the illuminating device with LED light source according to the present invention includes a circuit board, an elongate arch-sectioned transparent plate, and a lamp holder. The transparent plate is located below the circuit board, so that light emitted from LED lamps on the circuit board passes through the transparent plate before being projected outward. The circuit board has at least two LED lamps arranged thereon inline. The arch-sectioned transparent plate is provided on an outer surface with a plurality of curved ridges, which are parallelly and closely arranged side by side. Lights emitted from the LED lamps and passed through the arch-sectioned transparent plate are condensed by the curved ridges. Therefore, light is distributed on the curved ridges to form a plurality of densely arranged linear light sources, which make the arch-sectioned transparent plate with the curved ridges a complete area light source.

The elongated arch-sectioned transparent plate has a length and a width large enough for covering all the LED lamps. And, each of the curved ridges on the arch-sectioned transparent plate forms a convex lens to provide the light condensing effect.

The circuit board and the arch-sectioned transparent plate are assembled to the lamp holder.

The illuminating device with LED light source according to the present invention is advantageous because it converts a plurality of point light sources provided by the LED lamps into an area light source to eliminate the problem of overlapped images that are usually caused by multiple point light sources. Therefore, the LED illuminating device of the present invention can conveniently substitute for the conventional lighting devices.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of an illuminating device with LED light source according to a preferred embodiment of the present invention;

FIG. 2 is a fragmentary sectional view of the illuminating device of FIG. 1;

FIG. 3 is an exploded perspective view showing an arch-sectioned transparent plate of the illuminating device is separated from a lamp holder thereof; and

FIG. 4 is a sectional view taken along line 4-4 of FIG. 2.

### DETAILED DESCRIPTION OF THE PREFERRED EMBODIMENTS

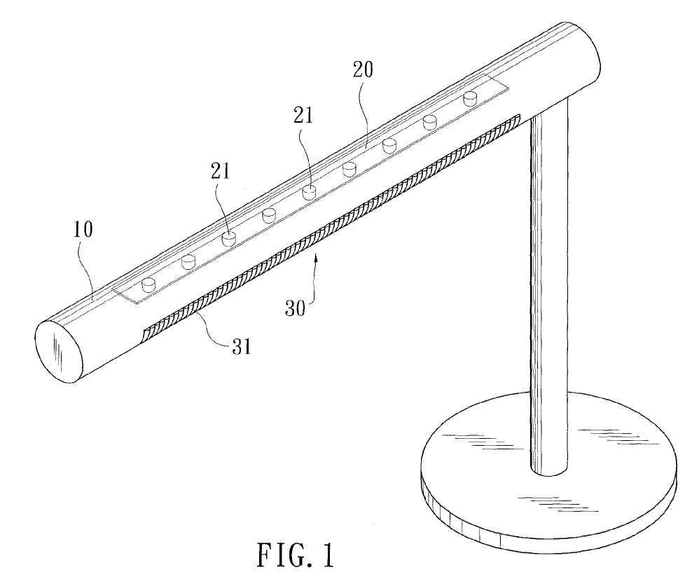

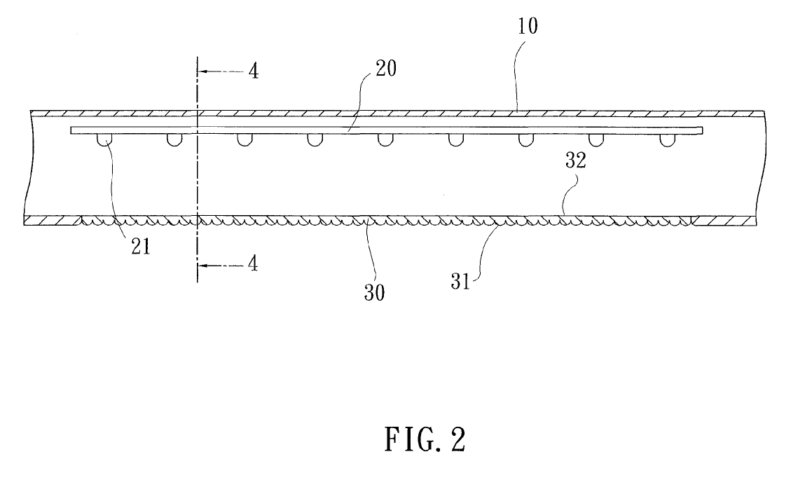

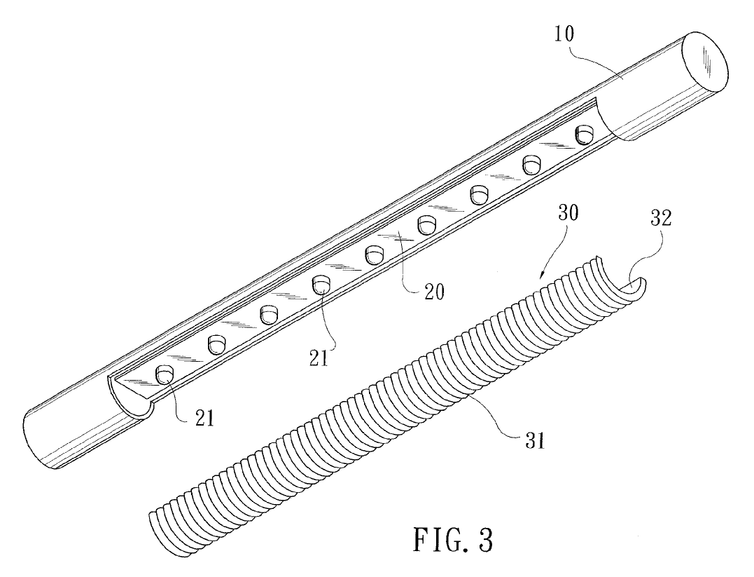

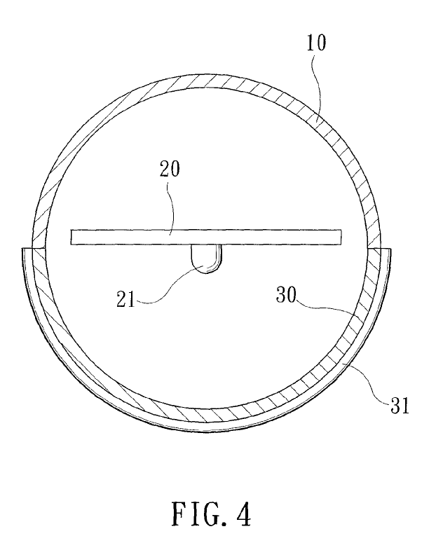

Please refer to FIGS. 1 to 4. An illuminating device with LED light source according to a preferred embodiment includes a circuit board 20, an elongate arch-sectioned transparent plate 30, and a lamp holder 10. The arch-sectioned transparent plate 30 is located below the circuit board 10, so that lights emitted from a plurality of LED lamps 21 mounted on the circuit board 20 must first pass through the plate 30 before being projected outward.

The LED lamps 21 can be arranged in line on the circuit board 20. The number of the LED lamps 21 is at least two. In the illustrated preferred embodiment, there are nine LED lamps 21. Since the illuminating device is used to illuminate downward, the LED lamps 21 are mounted to a lower face of the circuit board 20.

The arch-sectioned transparent plate 30 has a length and a width sufficient for covering all the LED lamps 21 on the circuit board 20. An outer surface of the plate 30 is formed with a plurality of curved ridges 31, which are parallelly and closely arranged side by side. The curved ridges 31 form a series of parallel convex lenses to provide a light condensing effect. That is, the arch-sectioned transparent plate 30 has a plurality of condensing lenses densely arranged thereon. In determining a curvature for the arch-sectioned transparent plate 30, it is preferable the cross section of the plate 30 is a segment with the LED lamp 21 as a center of circle thereof. The curved ridges 31 on the plate 30 each have an extending direction perpendicular to an extending direction of the line of LED lamps 21.

The circuit board 20 and the arch-sectioned transparent plate 30 are assembled to the lamp holder 10 to form a main structural body of the illuminating device. The lamp holder 10 is internally provided with a circuit system (not shown), which mainly provides a normal power supply path. Since the circuit system is a known skill and not a technical characteristic to be claimed in the present invention, it is not discussed herein.

When the light downward emitted from the LED lamps 21 on the circuit board 20 passes through the arch-sectioned transparent plate 30, each of the curved ridges 31 on the outer surface of the plate 30 forms a linear light source due to the light condensing effect of the curved ridges 31. And, since the curved ridges 31 are successively and closely arranged side by side, the linear light sources from the curved ridges 31 can together form an area light source. That is, when projecting on the arch-sectioned transparent plate 30, the lights emitted from the LED lamps 21 on the circuit board 20 are evenly distributed in the whole arch-sectioned transparent plate 30, making the arch-sectioned transparent plate 30 an area light source.

In the illustrated preferred embodiment, when the transparent plate 30 is assembled to the lamp holder 10, the curved ridges 31 on the transparent plate 30 each have two ends extended forward and rearward, respectively, while the line of LED lamps 21 on the circuit board 20 assembled to the lamp holder 10 is extended leftward and rightward. Therefore, increased number of curved ridges 31 can be provided on the outer surface of the transparent plate 30 to enable the lights from the LED lamps 21 to be highly evenly distributed on the transparent plate 30.

The LED lamps 21 are equally spaced on the circuit board 20. The arch-sectioned transparent plate 30 must be so located that it can be entirely irradiated by the lights emitted from the LED lamps 21. In the event a distance between the plate 30 and the circuit board 20 is too small, some areas on the plate 30 might not be irradiated by the lights from the LED lamps 21 to thereby form dark areas on the plate 30, preventing the plate 30 to form a complete area light source. In the preferred embodiment of the illuminating device, the distance between the circuit board 20 and the arch-sectioned transparent plate 30 is preferably equal to or slightly larger than a distance between two adjacent LED lamps 21.

In the above illustrated embodiment, although the LED lamps 21 are respectively a point light source, the provision of the arch-sectioned transparent plate 30 would make the lights emitted from the LED lamps 21 and passed through the arch-sectioned transparent plate 30 to project as a complete area light source without producing overlapped images of an object below the illuminating device.

An inner surface of the arch-sectioned transparent plate 30 can be a frosted face, so that the lights from the LED lamps 21 reaching at the arch-sectioned transparent plate 30 are diffused and become more evenly distributed over the plate 30. The diffused lights are then condensed by the curved ridges 31 to highly evenly project outward.

In brief, the illuminating device with LED light source according to the present invention utilizes an arch-sectioned transparent plate having a plurality of curved ridges densely and closely formed on an outer surface thereof to convert point light sources from two and more LED lamps into an area light source to thereby eliminate the problem of overlapped images. The illuminating device of the present invention can be applied to table lamps having a long tube as well as ceiling lamps to substitute for the conventional elongated fluorescent lamps.

What is claimed is:

1. An illuminating device with LED light source, comprising:
a circuit board having at least two LED lamps mounted to a lower side of the circuit board and arranged in line to equally space from one another;
an arch-sectioned transparent plate being located below the circuit board and being large enough to cover all the LED lamps on the circuit board; an outer surface of the arch-sectioned transparent plate being provided with a plurality of curved ridges, which are parallelly and closely arranged side by side and have an extending direction perpendicular to an extending direction of the line of LED lamps; and the LED lamps are located at an axis of center of the arch-sectioned transparent plate; and
a lamp holder, to which the circuit board and the arch-sectioned transparent plate are assembled.

2. The illuminating device with LED light source as claimed in claim 1, wherein a distance between two adjacent LED lamps is equal to a distance between the circuit board and the arch-sectioned transparent plate.

3. The illuminating device with LED light source as claimed in claim 1, wherein the arch-sectioned transparent plate has a frosted inner surface.
